(19) United States
(12) Patent Application Publication
(10) Pub. No.: US 2004/0053618 A1
(43) Pub. Date: Mar. 18, 2004

(54) Management of calls to a roaming subscriber

(76) Inventors: Eva-Maria Leppanen, Tampere (FI); Jani Palkola, Tampere (FI); Veijo Partanen, Tampere (FI); Kirsi Malk, Espoo (FI); Risto A. Pitkanen, Tampere (FI); Timo I. Tuunanen, Tampere (FI); Jenni Rissanen, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/450,920

(22) PCT Filed: Dec. 22, 2000
(86) PCT No.: PCT/EP00/13249

(51) Int. Cl. H04Q 7/20

(52) U.S. Cl. 455/445

(57) ABSTRACT

The invention proposes a method for establishing a connection between two communication terminals, comprising the steps of receiving a request for establishing a connection from a first communication terminal (TA) to a second communication terminal (TB), checking whether the second communication terminal (TB) is roaming in a second network (N2), and in case the second communication terminal (TB) is roaming, informing the first communication terminal (A) that the second communication terminal (TB) is roaming in the second network and allowing the user of the first communication terminal (TA) to select between different options how the call is to be handled, and controlling the establishment of a connection between the two communication terminals according to the selection of the user of the first communication terminal (TA). The invention also proposes a method in which the called, i.e., the second communication terminal has the possibility to select different options to handle a call.

### FIELD OF THE INVENTION

The present invention relates to a method for controlling the establishment of a connection between two communication terminals, wherein one of the communicating terminals is roaming.

### BACKGROUND OF THE INVENTION

The present invention concerns the situation when a subscriber is abroad and roaming in a foreign network. Roaming in a foreign or visited network always involves extra costs, i.e., roaming fees for a telephone call. When, for example, a subscriber B is roaming in a foreign network and another subscriber A calls B, there is a problem to decide who has to pay the roaming fee. Presently, in GSM the called subscriber B has to pay the additional roaming fee. This is because the calling subscriber possibly does not know that the subscriber B is abroad. Therefore, he can not be expected to pay the extra fees.

However, these extra roaming fees can be very high. The cost for merely pressing the answer button can sometimes be very expensive, as in some places there is a minimum charge of 1 minute per call and a roaming charge (international leg) of even ε 2 per minute.

Usually, caller identification (e.g. caller number) is not available when roaming or, in case the caller number is available, the subscriber B does not recognise it.

Therefore, the called subscriber B located abroad is not able to distinguish who is calling him. In this situation it is very annoying for the called subscriber when he is called by someone calling to the wrong number or by an advertiser.

Thus, if a person does not want to or is not able to spend a lot of money for the extra roaming fees, he will not answer the incoming calls or he even chooses to switch off his mobile terminal when travelling abroad, even though his mobile terminal may be globally compatible. That is, he cannot answer important calls. Hence, due to the rigid charging system, the advantages of mobile communication are ruined.

### SUMMARY OF THE INVENTION

Therefore, the object underlying the invention resides in removing the above drawbacks of the prior art and to enable a possibility of being reachable when roaming in other networks without having to pay additional roaming fees.

This object is solved by a method for establishing a connection between two communication terminals, comprising the steps of

receiving a request for establishing a connection from a first communication terminal to a second communication terminal,

checking whether the second communication terminal is roaming in a second network,

in case the second communication terminal is roaming,

informing the first communication terminal that the second communication terminal is roaming in the second network and allowing the user of the first communication terminal to select between different options how the call is to be handled, and controlling the establishment of a connection between the two communication terminals according to the selection of the user of the first communication terminal.

Alternatively, the above object is solved by a method for establishing a connection between two communication terminals, comprising the steps of

receiving a request for establishing a connection from a first communication terminal to a second communication terminal,

checking whether the second communication terminal is roaming in the second network,

in case the second communication terminal is roaming,

informing the second communication terminal that a first communication terminal wishes to establish a connection and allowing the user of the second communication terminal to select between different options how the call is to be handled, and controlling the establishment of a connection between the two communication terminals according to the selection of the user of the second communication terminal.

Hence, according to the invention the calling person or the called person or even both of them can decide how a call is to be handled when one of them is roaming. For example, if a caller really wants to get an important call through to the roaming called subscriber, he can take care of the roaming costs, get the called subscriber informed about that the roaming costs have already been paid by the calling subscriber and thus get the called subscriber to answer.

Thus, a person is able to roam abroad and can be reachable although he does not want to pay expensive roaming calls.

The above two methods can also be combined. That is, both of the users can be asked by the service how a call is to be handled in case one of the users is roaming.

The call handling option which can be selected by the subscribers may comprise indicating of paying the cost of international roaming. That is, one of the subscriber may indicate to the other subscriber that he is willing to pay the roaming costs.

The checking step may be performed by a Service Control Point (SCP).

The informing and selecting steps may be performed using Wireless Telephony Application (WTA). functionality. In particular, the corresponding control can be performed by a Wireless Telephony Application (WTA) server or by an IN/WTA server (IN: Intelligent Network). Thus, the specific features of Wireless Application Protocol (WAP) and WTA can be used.

Alternatively, informing and selecting may be controlled by using Simple Retransmission Protocol (SRP). This is not effective as WAP/WTA, but can be used in simpler network environments which do not support WAP, for example.

The options which can be selected may comprise accepting or not accepting a call, or sending a message to the other communication terminal instead of establishing the call. This message may be for instance an SMS, Voice Message, an instant message, a multimedia message, a unified message or an email. By this measure, the calling or called person can choose a cheap way of transmitting a message to a second person in case the calling or called person is not willing to take over the roaming fee.

The invention also proposes a network system comprising

a first network, a second network, a first communication terminal capable of being connected to the first network and a second communication terminal capable of being connected to the first or the second network,

wherein the first network is adapted to receive a request for establishing a connection from the first communication terminal to the second communication terminal, and to check whether the second communication terminal is roaming in the second network, and

wherein the first network is adapted to inform the first communication terminal, in case the second communication terminal is roaming, that the second communication terminal is roaming in the second network and to allow the user of the first communication terminal to select between different options how the call is to be handled, and to control the establishment of a connection between the two communication terminals according to the selection of the user of the first communication terminal.

Alternatively, a network system may comprise

a first network, a second network, a first communication terminal capable of being connected to the first network and a second communication terminal capable of being connected to the first or the second network,

wherein the first network is adapted to receive a request for establishing a connection from the first communication terminal to the second communication terminal, and to check whether the second communication terminal is roaming in the second network, and

wherein the first network is adapted to allow the user of the second communication terminal, in case the second communication terminal is roaming, to select between different options how the call is to be handled, and to control the establishment of a connection between the two communication terminals according to the selection of the user of the second communication terminal.

The invention also proposes a communication terminal comprising

a selection means which is adapted to receive a message indicating a plurality of options to handle a call when the communication terminal is calling a communication terminal and one of the communication terminals is roaming, wherein

the selection means has an input means by which a user of the communication terminal can select one of the options, and

the selection means is adapted to send the selected option to the network to which the communication terminal is connected.

### BRIEF DESCRIPTION OF THE DRAWINGS

The present invention will be more readily understood with reference to the accompanying drawings in which:

FIG. 1 shows a network system in which the method of the embodiment is applicable,

FIG. 2 shows a signaling diagram illustrating a process of allowing a decision about handling a call by a calling subscriber according to the first embodiment, and

FIG. 3 shows a signaling diagram illustrating a process of allowing a decision about handling a call by a called subscriber according to the first embodiment.

### DETAILED DESCRIPTION OF A PREFERRED EMBODIMENT

In the following, a preferred embodiment of the invention are described in more detail with reference to the accompanying drawings.

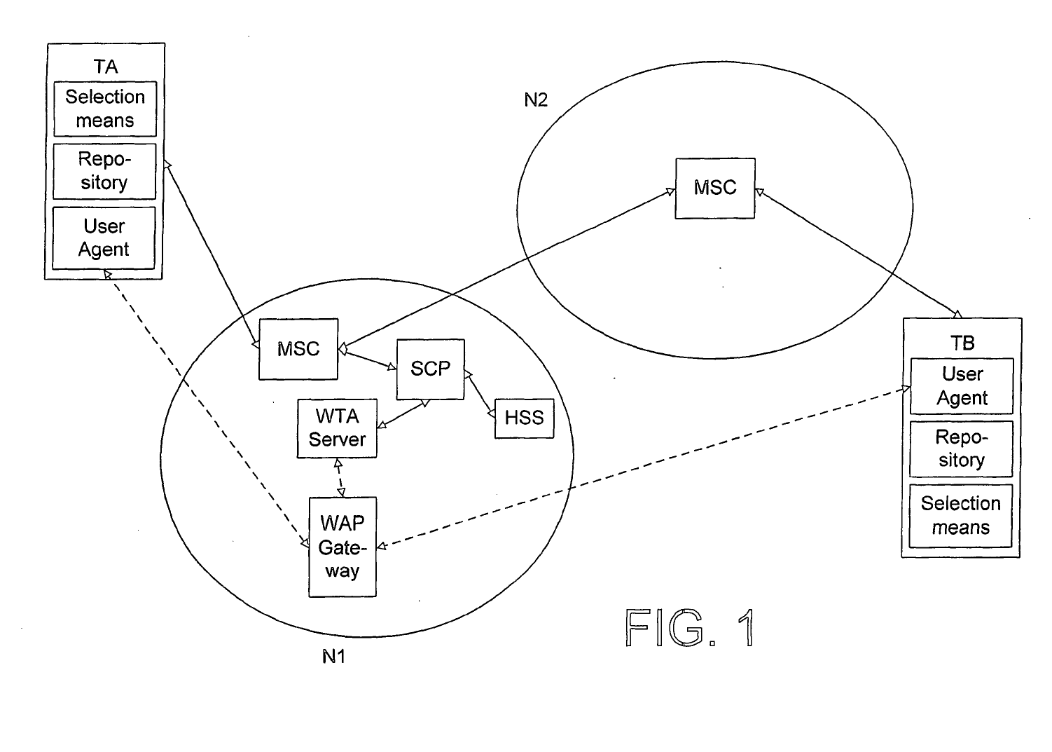

FIG. 1 shows a network system in which the method of the embodiment is applicable. It is noted that only the parts important for describing the embodiments are illustrated and that other parts are omitted for simplifying the description.

A first mobile terminal TA used by a subscriber A is located in a network N1. The mobile terminal is provided with WAP (Wireless Application Protocol) functionality. That is, it comprises a user agent and a repository. A user agent is any software or device that interprets resources. This may include textual browsers, voice browsers, search engines and the like. In the present case, the WTA (Wireless Telephony Application) functionality of WAP is important. Thus, the user agent may be a WTA User Agent which uses WTA framework. The repository is a persistent storage containing resources. The repository is used in WAP in order that particular resources (network data objects or services that can be identified by a URL) do not have to be re-loaded each time a user needs it. Due to the rather low transmission rate (e.g. 9, 6 kb/s in GSM system) this would lead to very long waiting time until the user actually can input commands or the like. Hence, parts of the resources can be stored in the repository.

In addition, the mobile terminal TA comprises a selection means. This selection means is described later.

The first network N1 comprises a Mobile Switching Center MSC to which the mobile terminal TA can be connected. It is noted that this connection is provided with a radio access network, which is not illustrated. The MSC is connected to a Service Control Point SCP which coordinates and controls various call related services and functions. The SCP can access a Home Subscriber Server HSS in which data of the subscribers are stored.

Furthermore, the SCP can also access a Wireless Telephony Application (WTA) server that provides WTA services. The WAP part of the mobile terminal A is connected via a WAP gateway with the WTA server.

A second network N2 also comprises a Mobile Switching Center MSC. The WAP/WTA services, however, are provided by the first network N1 so that the second network does not have to comprise a WAP server.

In the following, it is assumed that subscriber B roams in the second network N2. It can also be assumed due to the roaming in the second network N2, not being the home network of subscriber B, extra cost will be generated for calls.

The service according to the invention can be provided as an originating service, i.e., the subscriber A who initiates the call controls the establishment of the connection. Alternatively, the service can be provided as a terminating service, wherein the called subscriber B controls the establishment of the connection. Still another alternative is that the service is provided as a combination of the two, originating and terminating services.

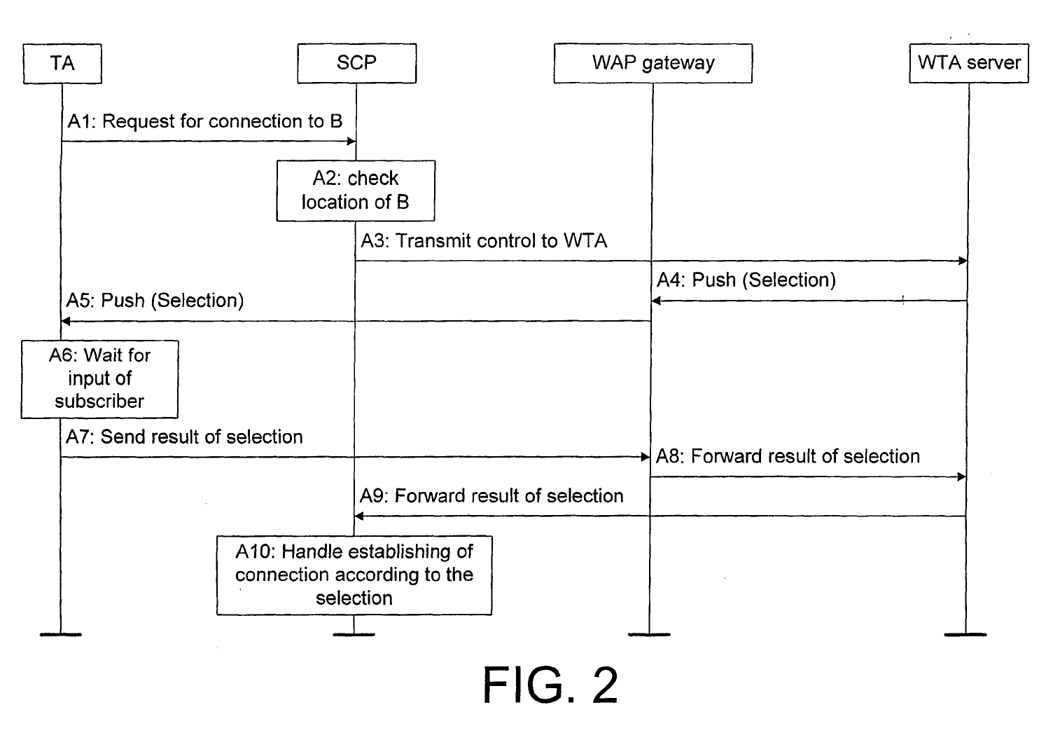

Next, by referring to the signaling diagram shown in FIG. 2, the procedure for establishing a connection between the mobile terminals TA and TB is described, wherein the service is provided as an originating service. It is noted that only that signaling necessary to describe the present embodiment is illustrated, since otherwise the description would be too complex.

In step A1, subscriber A wants to establish a call with subscriber B. Therefor, he dials the number of B and the mobile terminal TA initiates the call by sending a connection establishment request to the SCP. At this moment, the subscriber A is not aware about the location of the subscriber B. The SCP checks the location of B in step A2. The SCP can do this by referring to the HSS which can deliver the location information regarding B. In the present case, it is assumed that the mobile terminal TB (i.e., the called subscriber) is located in the area of the network N2, is roaming.

In response to this-detection, the SCP triggers the WTA functionality in the IN in step A3. That is, the SCP forwards a message the WTA server in order to inform the WTA server that A wants to establish a connection to the subscriber B which is located in another network.

Based on this information, the WTA sends a message to the mobile terminal A in order to inform the user thereof about roaming of the mobile terminal B. This can be executed in form of a WAP push message. A push message is a message which a server sends to a client without the client requesting it. That is, the server initiates the content delivery.

This push message is forwarded from the WTA server to the mobile terminal TA via the WAP gateway in steps A4 and A5.

In the present case, the push message can contain an object which allows subscriber A to make a selection between different options. This object can be a so-called card which is a single WML or WTA-WML unit of navigation and user interface. Such a card can contain information which are to be presented on the screen, instructions for gathering user input, etc. Such a card is made of WMLScript, for example.

For example, the card can offer the following options to the subscriber:

1. Connect and let the subscriber B pay for the international roaming part

2. Connect and pay for the roaming part

3. Connect to the Voice Mail of the subscriber B

4. Send an SMS to the subscriber B

5. Disconnect call

The option 1 corresponds to the current situation in GSM. In the option 2, the tariff should be displayed such that the calling subscriber A knows how much he has to pay for the call. This option may be selected by the calling subscriber A in case it is an important call and he wishes in any case that the subscriber B actually answers the call. Option 3 or option 4 may be selected in case the subscriber A only wants to notify something to subscriber B. Option 5 may be selected in case the call is useless since the called subscriber B is abroad. For example, this option may be selected in case the subscriber A would like to invite subscriber B to a meeting or the like within the next hours, which would be meaningless in case the called subscriber B is thousands of kilometers away.

The subscriber A can choose between the different options by inputting the corresponding number or by scrolling a cursor or the like.

It is noted that the above list of options can be stored in the repository of the mobile terminal TA. By this measure, it is not necessary to always load the complete card from the WTA server to the mobile terminal TA. Hence, the time for establishing a connection can be shortened.

Depending on the options, further actions can be taken in the mobile terminal TA. For example, in case the subscriber selects option 4, i.e., sending an SMS, a process for inputting a short message can be started.

The result of the selection made by the subscriber A is returned to the WTA server via the WAP gateway in steps A7 and A8. The WTA server in turn forwards the result of the selection to the SCP in step A9.

In step A10, the SCP handles the call according to the choice of the calling subscriber A. For example, the SCP generates a charging record including information how the call is paid (in options 1 and 2), establishes a connection to the Voice Mail of subscriber B (option 3) or disconnects the call (option 5).

The SMS (option 4) may be sent directly from the user's terminal using the WTAI (Wireless Telephony Application Interface) send text version, for example.

But not only the calling subscriber A may select how a call to a roaming subscriber is to be handled, also the roaming called subscriber B may select how a call is to be handled.

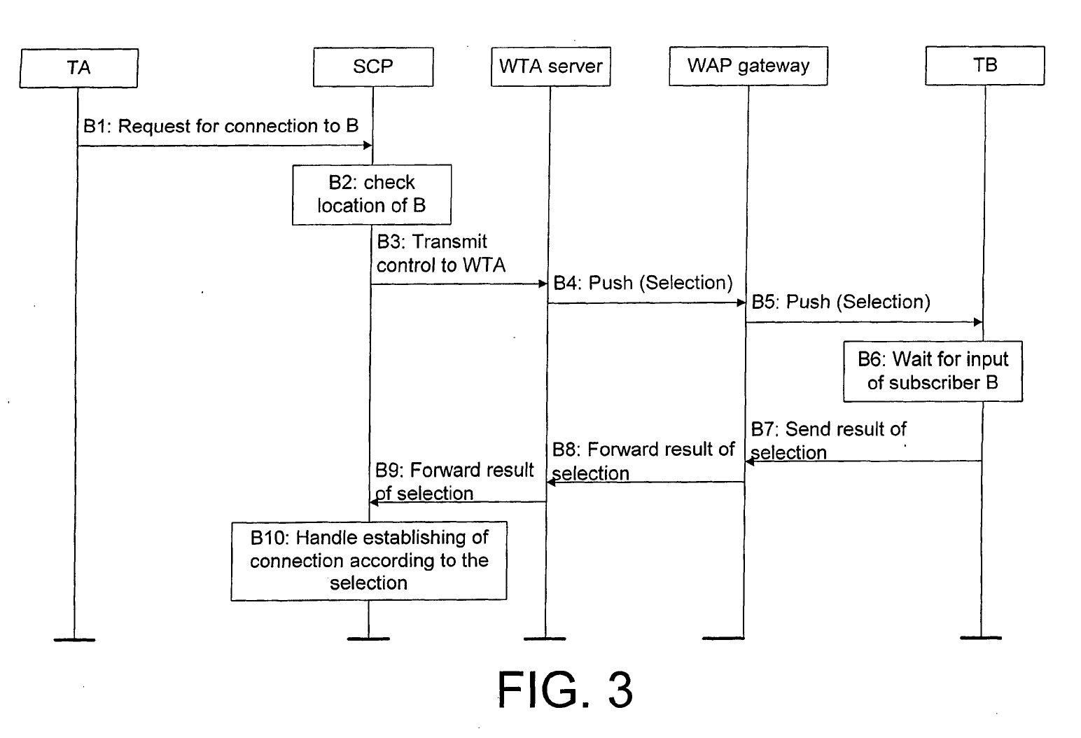

A process therefor is illustrated in the signaling diagram of FIG. 3 wherein the service is provided as a terminating service.

This process can be carried out after the process according to FIG. 2 is ended, such that both subscribers can decide how to handle establishing of the connection.

The process is similar to that of FIG. 2, therefore only the main differences are described in the following.

When a call from subscriber A to subscriber B is to be established, the first network N1 receives a corresponding request from the subscriber A. This request is handled by the IN (Intelligent Network) functionality of the first network, i.e., the SCP of the network N1.

The SCP checks the location of the called subscriber B in step B2. In case the SCP finds out that the subscriber B is located in the second network, i.e. that the subscriber A is calling the subscriber B who is roaming in the network N2, the control is transmitted to the WTA server in step B3. In turn, the WTA server forwards a WAP push message to the mobile terminal TB in steps B4 and B5, similarly to steps A4 and A5.

In step B6, the subscriber B gets information about who is calling and how subscriber A wishes to handle the call. That is, the number or the name of the caller is displayed and the tariff for the call is displayed. That is, the subscriber B gets informed whether he has to pay for it or whether the roaming fee has already been taken care of the by the subscriber A. Based on this information, he can choose whether he wishes to accept the call or not.

Furthermore, preferably the subscriber B can also select between different options as in the case of subscriber A. For example, the subscriber B can handle between the following options:

1. Accept the call

2. Disconnect the call

3. Send an SMS to subscriber A

4. Connect caller A to Voice Mail of Subscriber B

5. Connect to Voice Mail of Subscriber A.

The subscriber B may select option 3, 4 or 5 in case he does not want to answer the call at this point of time or in case he has to pay for the roaming fee but does not want to simply disconnect the call without notifying the caller.

The result of the selection is forwarded in steps B7, B8 and B9 via the WAP gateway and the WTA server to the SCP which handles the connection establishing according to the selection made by the subscriber B.

Furthermore, if an automatic call screening is invoked, the subscriber B can get the numbers from where call attempts have been made with the use of WTA notification so that he may contact the callers later.

After this, the usual call and connection control is executed. Since this is not part of the invention, a further detailed description thereof is omitted.

Nevertheless, it is noted that the charging information (i.e., who pays the roaming fee) is sent to the respective MSCs. Alternatively, the SCP may store the charging information and handle it.

Thus, according to the embodiment described above the invention is implemented as an IN/WTA server feature. The service is provisioned as a terminating service to the subscriber B, and both subscribers A and B need to have WTA capable handsets (communication terminals) in order to obtain a smooth and easy handling.

The above description and accompanying drawings only illustrate the present invention by way of example. Thus, the embodiment may vary within the scope of the attached claims.

In particular it is noted that the processes described in FIGS. 2 and 3 are independent from each other.

For example, only the first selection as described in connection with FIG. 2 can be executed. That is, only subscriber A can choose whether he is prepared to take over the roaming fee or not, to send an SMS or connect to the voice mail of subscriber B and the like, whereas subscriber B may not be able to obtain information regarding the calling subscriber A. Nevertheless, at least in this case the situation of the calling subscriber A is improved as compared to the present situation described in the introductory part.

However, in this situation, the subscriber B can be informed about the fact the subscriber A pays the roaming fees of an incoming calls by announcements or SMS.

In contrast thereto, there may be the case that only the second mobile terminal TB of the second subscriber B has WAP functionality. In this case, the subscriber A will start his call without knowing that the subscriber B is roaming. However, the subscriber B can select how he wants to handle the call. That is, he can select whether he is prepared to take over the roaming fee and to answer the call, or whether he wishes to send an SMS or to connect to the Voice Mail of subscriber A or to connect subscriber A to B's own Voice Mail. Thus, also in this case the situation for the called subscriber B is improved.

Furthermore, the use of the WAP and WTA functionality was described as an example only. Also other mechanisms to inform the subscribers and the allow them to make selections are applicable. For example, the service could be implemented by Simple Retransmission Protocol (SRP) using announcements.

In addition, SMS and voice message are only given as examples for messages to inform the other user how the call is handled. Alternatively, such a message may be, for instance, an instant message, a multimedia message, a unified message or an email.

Moreover, in the cases according the above-described embodiments, it may occur that it is not possible to simultaneously carry on with call establishment and push content to the user's terminal. This may occur in early GPRS (General Packet Radio System) networks, for example. In this case, the call establishment can be stopped before information is pushed to terminal TA so that the terminal TA of the user A is not busy anymore. The pushed content, i.e. the pushed WML deck may include a URL that can be used to continue (e.g., click-to-dial). That is, the WML deck is stored in the repository such that it can later be used without the need of pushing the WML deck again from the network.

1. A method for establishing a connection between two communication terminals, comprising the steps of
receiving a request for establishing a connection from a first communication terminal (TA) to a second communication terminal (TB),
checking whether the second communication terminal (TB) is roaming in a second network (N2),
in case the second communication terminal (TB) is roaming,
informing the first communication terminal (TA) that the second communication terminal (TB) is roaming in the second network and allowing the user of the first communication terminal (TA) to select between different options how the call is to be handled, and controlling the establishment of a connection between the two communication terminals according to the selection of the user of the first communication terminal (TA).

2. A method for establishing a connection between two communication terminals, comprising the steps of
receiving a request for establishing a connection from a first communication terminal (TA) to a second communication terminal (TB),
checking whether the second communication terminal (TB) is roaming in the second network (N2),
in case the second communication terminal (TB) is roaming,
informing the second communication terminal (TB) that a first communication terminal (TA) wishes to establish a connection and allowing the user (B) of the second communication terminal (TB) to select between different options how the call is to be handled, and
controlling the establishment of a connection between the two communication terminals according to the selection of the user (B) of the second communication terminal (TB).

3. The method according to claim 1 or 2, wherein the call handling options comprises indicating of paying the cost of international roaming.

4. The method according to claim 1 or 2, wherein the checking step is performed by a Service Control Point (SCP).

5. The method according to claim 1 or 2, wherein in the informing and selecting steps are performed using Wireless Telephony Application (WTA) functionality.

6. The method according to claim 4, wherein the informing and selecting steps are controlled by a Wireless Telephony Application (WTA) server.

7. The method according to claim 1 or 2, wherein the informing and selecting steps are performed using Simple Retransmission Protocol.

8. The method according to claim 1 or 2, wherein an option to be selected is accepting or not accepting a call.

9. The method according to claim 1, wherein an option to be selected is sending a message to the second communication terminal (TB) instead of establishing the call.

10. The method according to claim 2, wherein an option to be selected is sending a message to the calling communication terminal (TA) instead of accepting the call.

11. The method according to claim 9 or 10, wherein the message comprises at least one of the following: a SMS message, an instant message, a multimedia message, a unified message, an email and a voice message.

12. A network system comprising
a first network (N1), a second network (N2), a first communication terminal (TA) capable of being connected to the first network (N1) and a second communication terminal (TB) capable of being connected to the first or the second network (N1, N2),
wherein the first network (N1) is adapted to receive a request for establishing a connection from the first communication terminal (TA) to the second communication terminal (TB), and to check whether the second communication terminal (TB) is roaming in the second network (N2), and
wherein the first network (N1) is adapted to inform the first communication terminal (TA), in case the second communication terminal (TB) is roaming, that the second communication terminal (TB) is roaming in the second network (N2) and to allow the user (A) of the first communication terminal (TA) to select between different options how the call is to be handled, and to control the establishment of a connection between the two communication terminals according to the selection of the user (A) of the first communication terminal (TA).

13. A network system comprising
a first network (N1), a second network (N2), a first communication terminal (TA) capable of being connected to the first network (N1) and a second communication terminal (TB) capable of being connected to the first or the second network (N1, N2),
wherein the first network (N1) is adapted to receive a request for establishing a connection from the first communication terminal (TA) to the second communication terminal (TB), and to check whether the second communication terminal (TB) is roaming in the second network (N2), and
wherein the first network (N1) is adapted to allow the user (B) of the second communication terminal (TB), in case the second communication terminal (TB) is roaming, to select between different options how the call is to be handled, and to control the establishment of a connection between the two communication terminals according to the selection of the user (B) of the second communication terminal (TB).

14. The network system according to claim 12 or 13, wherein the call handling options comprises indicating of paying the cost of international roaming.

15. The network system according to claim 12 or 13, further comprising a Service Control Point (SCP) which is adapted to perform the check whether the second communication terminal is roaming.

16. The network system according to claim 12 or 13, wherein in the informing and selecting functions are performed using Wireless Telephony Application (WTA) functionality.

17. The network system according to claim 16, further comprising a Wireless Telephony Application (WTA) server which is adapted to control informing and selecting functions.

18. The network system according to claim 12 or 13, wherein the informing and selecting functions are performed using Simple Retransmission Protocol.

19. The network system according to claim 12 or 13, wherein an option to be selected is accepting or not accepting a call.

20. The network system according to claim 12, wherein an option to be selected is sending a message to the second communication terminal (TB) instead of establishing the call.

21. The network system according to claim 13, wherein an option to be selected is sending a message to the calling communication terminal (TA) instead of accepting the call.

24. The network system according to claim 20 or 21, wherein the message comprises at least one of the following: a SMS message, an instant message, a multimedia message, a unified message, an email and a voice message.

25. A communication terminal comprising
a selection means which is adapted to receive a message indicating a plurality of options to handle a call when the communication terminal (TA) is calling a communication terminal (TB) and one of the communication terminals (TA, TB) is roaming, wherein
the selection means has an input means by which a user (A) of the communication terminal (TA) can select one of the options, and
the selection means is adapted to send the selected option to the network (N1) to which the communication terminal (TA) is connected.

26. The communication terminal according to claim 25, wherein the call handling options comprises indicating of paying the cost of international roaming.
